(19) United States
(12) Patent Application Publication
(10) Pub. No.: US 2023/0181287 A1
(43) Pub. Date: Jun. 15, 2023

(54) DENTAL APPLIANCE AND METHOD OF MANUFACTURING THE SAME

(71) Applicant: Christian Hahn, Milton, GA (US)

(72) Inventor: Christian Hahn, Milton, GA (US)

(21) Appl. No.: 18/078,503

(22) Filed: Dec. 9, 2022

Related U.S. Application Data
(60) Provisional application No. 63/287,836, filed on Dec. 9, 2021.

(51) Int. Cl. A61C 7/08

(52) U.S. Cl. CPC A61C 7/08

(57) ABSTRACT

A dental appliance, according to various embodiments, comprises a shell defining a cavity configured to receive a plurality of teeth (e.g., maxillary or mandibular teeth). In various embodiments, the shell defines an occlusal surface that extends from each of a right and left posterior occlusal point to an anterior occlusal point. In particular embodiments, the shell has a first thickness at each of the posterior occlusal points, and a second thickness at the anterior occlusal point. In various embodiments, the second thickness is greater than the first thickness. In such embodiments, the ratios of the second thickness to the first thickness may at least partially correspond to a ratio of an anterior occlusal distance to a posterior occlusal distance of a dental patient. In particular embodiments the ratio may be between about 2:1 and about 4:1. In a particular embodiments, the ratio is 3:1.

### CROSS-REFERENCE TO RELATED APPLICATIONS

This application claims priority from U.S. Provisional Patent Application Ser. No. 63/287,836, filed Dec. 9, 2021, which is hereby incorporated herein by reference in their entirety.

### BACKGROUND

Many dental treatments involve repositioning misaligned teeth and changing bite configurations for improved cosmetic appearance and dental function. Repositioning can be accomplished, for example, by applying controlled forces to one or more teeth over a period of time. Some dental processes use dental positioning appliances, rather than braces, for realigning teeth. Such appliances may, for example, utilize a thin shell of material having resilient properties, referred to as an “aligner” that generally conforms to a patient's teeth but may be slightly out of alignment with the present (e.g., initial) tooth configuration.

Placement of the appliance over the teeth may provide controlled forces in specific locations to gradually move the teeth into a new configuration. Repetition of this process with successive appliances that provide progressive configurations eventually move the teeth through a series of intermediate arrangements to a final desired arrangement.

Reaching a final, desired tooth configuration may be difficult when using a shell or other aligner when compared to traditional braces. As such, there is a need for improved dental appliances that address these and other difficulties

### SUMMARY

A dental appliance, according to various embodiments, comprises a shell defining: (1) a cavity configured to receive a plurality of teeth; and (2) an occlusal portion that extends from a posterior occlusal point to an anterior occlusal point. In some embodiments: (1) the shell has a first thickness at the posterior occlusal point and a second thickness at the anterior occlusal point; and (2) the second thickness is greater than the first thickness. In particular embodiments, a ratio of the second thickness to the first thickness may comprise: (1) a two-to-one ratio; (2) a three-to-one ratio; and (3) a four-to one ratio.

In some embodiments, the shell comprises at least one of: (1) a first shell configured to receive a plurality of maxillary teeth; or (2) a second shell configured to receive a plurality of mandibular teeth. In particular embodiments: (1) the shell is the first shell configured to receive the plurality of maxillary teeth; (2) the dental appliance further comprises the second shell configured to receive the plurality of mandibular teeth; (3) the second shell defines: (a) a second cavity configured to receive the plurality of mandibular teeth; and (b) a second occlusal portion that extends from a second posterior occlusal point of the second shell to a second anterior occlusal point of the second shell; (4) the second shell has a third thickness at the second posterior occlusal point and a fourth thickness at the second anterior occlusal point; (5) the first thickness and the third thickness combine to a fifth thickness; (6) the second thickness and the fourth thickness combine to a sixth thickness; and (7) the sixth thickness is greater than the fifth thickness. In particular embodiments, a ratio of the sixth thickness to the fifth thickness is between about a 2:1 and a 4:1 ratio. In some embodiments, the dental appliance may comprise, for example: (1) a retainer; (2) an aligner; (3) a bite guard; or (4) a sport guard.

In various embodiments, each portion of the shell other than the occlusal portion has a substantially uniform thickness. In such embodiments, the uniform thickness may be the first thickness. In still other embodiments: (1) the occlusal portion defines a posterior occlusal surface contact point adjacent the posterior occlusal point and an anterior occlusal surface contact point adjacent the anterior occlusal point; and (2) the dental appliance is configured such that the posterior occlusal surface contact point and the anterior occlusal surface contact point are substantially simultaneously in contact with an opposing set of teeth when a patient is wearing the dental appliance and the patient's mouth is in a closed position.

A dental appliance, according to various embodiments, comprises a maxillary teeth shell comprising a maxillary occlusal portion that extends from a right maxillary posterior occlusal point and a left maxillary posterior occlusal point to a maxillary anterior occlusal point. In some embodiments, the maxillary teeth shell has: (1) a first thickness at the right maxillary posterior occlusal point and the left maxillary posterior occlusal point; and (2) a second thickness at the maxillary anterior occlusal point. In particular embodiments, the second thickness is greater than the first thickness. In particular embodiments, a ratio of the second thickness to the first thickness may comprise, for example: (1) a two-to-one ratio; (2) a three-to-one ratio; and (3) a four-to one ratio. In various embodiments, each portion of the maxillary teeth shell other than the maxillary occlusal portion has a substantially even thickness. In such embodiments, the substantially even thickness may be the first thickness.

In particular embodiments, the dental applicant further comprises a mandibular teeth shell comprising a mandibular occlusal portion that extends from a right mandibular posterior occlusal point and a left mandibular posterior occlusal point to a mandibular anterior occlusal point. In such embodiments, the mandibular teeth shell may have: (1) a third thickness at the right mandibular posterior occlusal point and the left mandibular posterior occlusal point; and (2) a fourth thickness at the mandibular anterior occlusal point. In any embodiment described herein, a ratio of a sum of the first thickness and third thickness to a sum of the second thickness and the fourth thickness may comprise a ratio between about 1:2 and about 1:4.

A method of manufacturing a removable dental applicant, in various embodiments, comprises: (1) measuring a posterior occlusal distance of a patient; (2) measuring an anterior occlusal distance of the patient; (3) determining a first ratio of the posterior occlusal distance to the anterior occlusal distance; and (4) manufacturing a dental appliance comprising a shell defining: (A) a cavity configured to receive a plurality of teeth; and (B) an occlusal portion that extends from a posterior occlusal point to an anterior occlusal point. In various embodiments: (1) the shell has a first thickness at the posterior occlusal point and a second thickness at the anterior occlusal point; and (2) a second ratio of the first thickness to the second thickness is the first ratio.

In particular embodiments, manufacturing the dental appliance comprises manufacturing the dental appliance such that each portion of the shell other than the occlusal portion has a substantially uniform thickness. In some aspects, the uniform thickness is the first thickness. In still other embodiments, manufacturing the dental appliance comprises manufacturing the shell such that the cavity is configured to receive a plurality of maxillary teeth. In various embodiments, the first ration is between about 1:2 and about 1:4. In particular embodiments, the dental appliance further comprises a second shell defining: (1) a second cavity configured to receive a plurality of mandibular teeth; and (2) a second occlusal portion that extends from a second posterior occlusal point of the second shell to a second anterior occlusal point of the second shell. In various embodiments: (1) the second shell has a third thickness at the second posterior occlusal point and a fourth thickness at the second anterior occlusal point; (2) the first thickness and the third thickness combine to a fifth thickness; (3) the second thickness and the fourth thickness combine to a sixth thickness; and (4) a third ratio of the fifth thickness to the sixth thickness is the first ratio.

### BRIEF DESCRIPTION OF THE DRAWINGS

Various embodiments of a data model generation and population system are described below. In the course of this description, reference will be made to the accompanying drawings, which are not necessarily drawn to scale, and wherein:

FIG. 1 is a side view depicting a closed human occlusion;

FIG. 2 is a side view depicting another closed human occlusion;

FIG. 3 is a simplified schematic side view of an open mouth;

FIG. 4 is a side view of human occlusion in a slightly open position;

FIG. 5 is a simplified schematic side view of an abnormal occlusion;

FIG. 6 is a simplified schematic side view of a dental appliance having a wedge-shaped occlusal surface;

FIG. 7 is a simplified schematic side view of the dental appliance of FIG. 6 in a simplified schematic of an open mouth;

FIG. 8 is a simplified schematic side view of a dental appliance according to another embodiment in a simplified schematic of an open mouth;

FIG. 9 is a perspective view of a dental appliance according to a particular embodiment;

FIG. 10 is a side view of the dental appliance of FIG. 9; and

FIG. 11 is a perspective view of a dental appliance according to het another embodiment.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A dental appliance, according to various embodiments, comprises a shell defining a cavity configured to receive a plurality of teeth (e.g., maxillary or mandibular teeth). In various embodiments, the shell defines an occlusal surface that extends from each of a right and left posterior occlusal point to an anterior occlusal point. In particular embodiments, the shell has a first thickness at each of the posterior occlusal points, and a second thickness at the anterior occlusal point. In various embodiments, the second thickness is greater than the first thickness. In such embodiments, the ratios of the second thickness to the first thickness may at least partially correspond to a ratio of an anterior occlusal distance to a posterior occlusal distance of a dental patient. In particular embodiments the ratio may be between about 2:1 and about 4:1. In a particular embodiments, the ratio is 3:1.

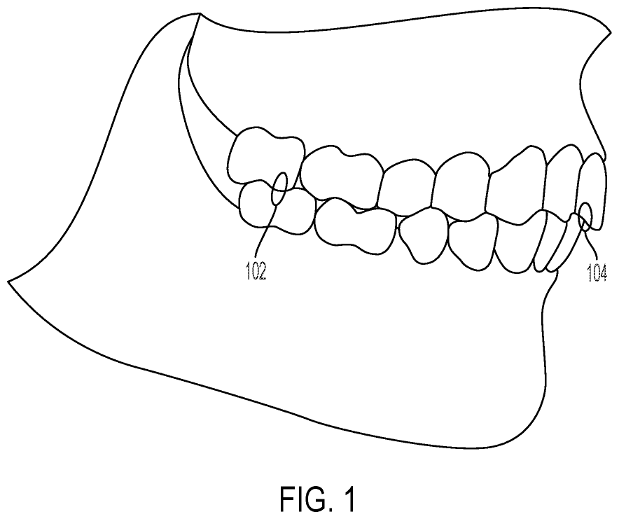

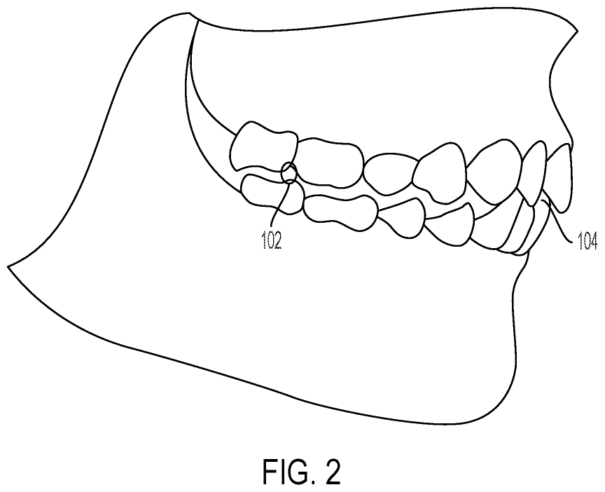

Traditional dental appliances, such as Invisalign braces, Clear Correct, Smile Direct, or other clear retainers, use clear trays or other materials. The thickness of these appliances at the posterior occlusion point of the appliance is about the same as the thickness at the anterior occlusion point of the appliance. This 1:1 ratio of the posterior occlusion point and the anterior occlusion point may not be compatible with the actual anatomical and physiological function of the TMJ (temporomandibular joint) and associated masticatory system. FIG. 1 depicts a side view of a substantially normal closed human occlusion. As may be understood from FIG. 1, a desired maxillary and mandibular tooth configuration results in a posterior occlusal surface contact point 102 and an anterior occlusal surface contact point 104 that are substantially even (i.e., such that there is no substantial gap or difference in gap at the upper and lower occlusal surfaces when the mouth is in a closed position). FIG. 2 depicts an exemplary closed human occlusion in which the posterior occlusal surface contact point 102 and the anterior occlusal surface contact point 104 are not substantially even, such that, when there is contact at the anterior occlusal surface contact point 104, there is a gap at the posterior occlusal surface contact point 102 when the mouth is in the closed position. As may be understood from the discussion herein, the lack of even contact at the posterior occlusal surface contact point 102 and the anterior occlusal surface contact point 104 may result from an abnormal human occlusion. For example, an abnormal occlusion may result from the use of dental appliances that do not account for the operating angle of the TMJ as it relates to occlusal contacts, or from any other suitable reason.

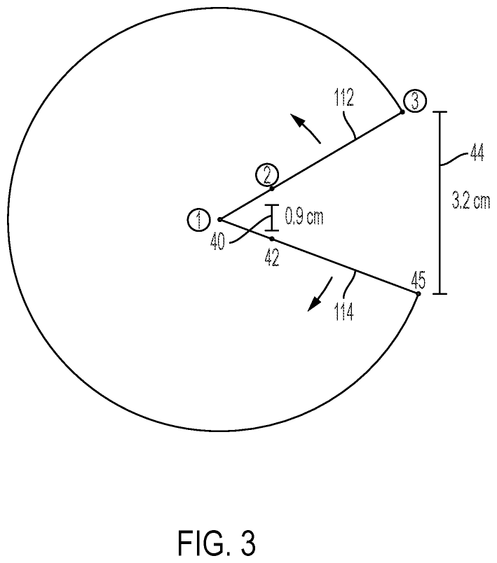

As may be understood by one skilled in the art, and as illustrated in FIG. 3, as the mouth is opened and closed, the TMJ 1 first functions as a hinge joint and then transforms into a sliding joint to increase the opening of the mouth. FIG. 3 depicts a schematic side view of an open mouth. In the embodiment shown in FIG. 3, the mouth is in the open position such that the maxillary teeth 112 and mandibular teeth 114 are spaced apart and form an angle with one another. Upon opening the mouth, the posterior occlusal distance 40, or the distance between the maxillary posterior occlusal point 2 and the mandibular posterior occlusion point 42, is less than the anterior occlusal distance anterior occlusal distance 44, or the distance between the maxillary anterior occlusal point 3 and the mandibular anterior occlusion point 45. In various embodiments, the ratio of the posterior occlusal distance 40 to the anterior occlusal distance 44 is about 1:3. In still other embodiments, the ratio of the posterior occlusal distance 40 to the anterior occlusal distance 44 may be in the range of a 1:1 to a 1:4 ratio. In particular embodiments the ratio may range from 1:1 to up to 1:4 or greater. In various aspects, the ratio may vary from person to person, but may average to around about 1:3.

Although FIG. 3 provides a simplified version of a mouth for illustrative purposes to illustrate the ratio between the posterior occlusal distance 40 and the anterior occlusal distance 44, it should be understood that the mouth functions slightly different than the arc as seen in FIG. 3, for example, because of the Curve of Spee of the mandible. It should be understood, however, that the occlusal separation between the posterior occlusal distance 40 and anterior occlusal distance 44, as measured between the maxillary and mandibular arch, is still different. As such, it may be desirable to utilize a dental appliance that accounts for this increase in separation distance between the posterior occlusal distance 40 and anterior occlusal distance 44 when the mouth is in the closed position. Such an appliance may, for example, properly stabilize the dental occlusal mechanism while providing the desired treatment provided by the dental appliance (e.g., snoring appliance, sports mouthguard, tooth realignment, etc.).

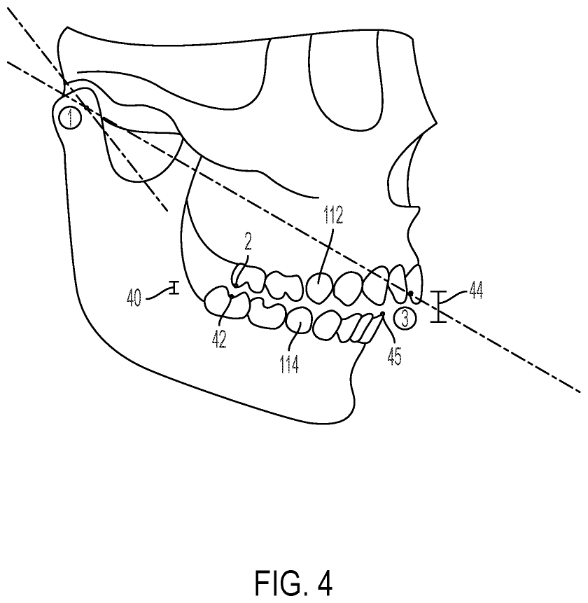

FIG. 4 depicts yet another representation of a mouth depicting TMJ function in a slightly open position. As may be understood from this figure, the posterior occlusal distance 40 and anterior occlusal distance 44 are not equal when the mouth is in a slightly open position.

As discussed herein, traditional dental appliances, such as Invisalign braces, Clear Correct, Smile Direct, or other clear retainers, use clear trays or other materials. The thickness of these appliances at the posterior occlusion point of the appliance is about the same as the thickness at the anterior occlusion point of the appliance. This 1:1 ratio of the posterior occlusion point and the anterior occlusion point may not be compatible with the actual anatomical and physiological function of the TMJ (temporomandibular joint) and associated masticatory system. FIG. 5 depicts a side view of a schematic drawing of a mouth position when using a dental appliance having a 1:1 ratio of the posterior occlusal distance 40 to the anterior occlusal distance 44. As may be understood from this figure, such a dental appliance may apply unwanted pressure on certain teeth and the jaw.

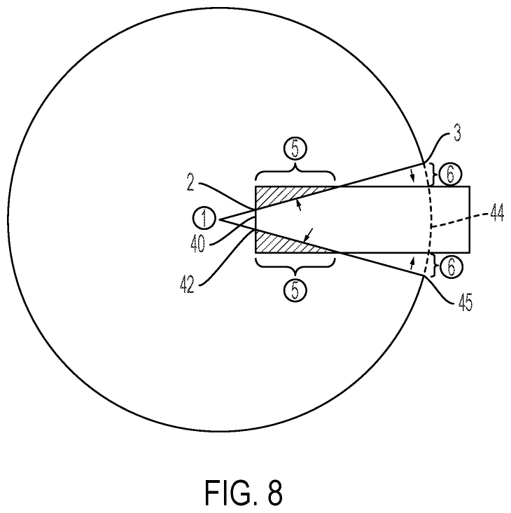

FIG. 8 depicts how such a ratio may cause a dental appliance to apply improper pressure at the maxillary posterior occlusion point 2, the mandibular posterior occlusion point 42, and the surrounding posterior area 5 of the appliances, resulting in excess force at the posterior occlusion points and surrounding posterior area 5 because there is no contact at the maxillary anterior occlusion point 3, the mandibular anterior occlusion point 45, and/or the surrounding anterior area 6.

This imbalance may result in intrusion of the posterior teeth, as well as other pathological issues in the TMJ, including an anterior heavy bite (e.g., excessive contact on the anterior teeth), such as is shown in FIG. 2. As discussed above, in a normal occlusion, such as shown in FIG. 1, even contact exists between all teeth such that there is even contact at the posterior occlusal surface contact point 102 and the anterior occlusal surface contact point 104.

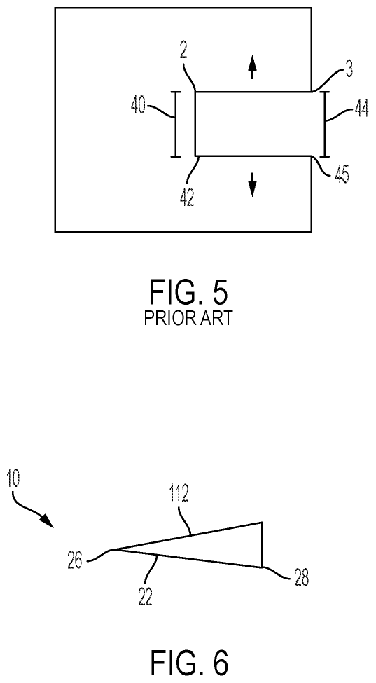

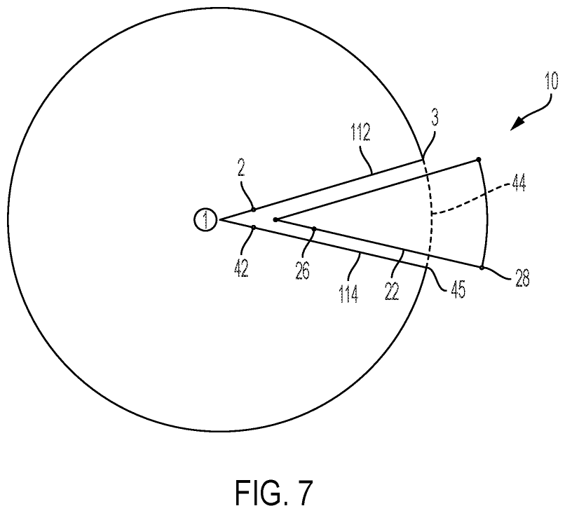

FIGS. 6 and 7 depict a simplified schematic side view of a dental appliance having a wedge-shaped occlusal surface both out of an in a simplified schematic of a human mouth. As may be understood from these figures, the dental appliance 10 is dimensioned to correspond to a difference in size of the posterior occlusal distance 40 and the anterior occlusal distance 44.

Exemplary embodiments of a dental appliance 10 are described more fully herein. These embodiments, in general, relate to wedge-shaped (e.g., substantially wedge-shaped) dental orthotic. Other embodiments relate to a system and method for maintaining and moving teeth in a physiologically correct way for providing a system and method of balancing, retaining, or moving teeth in a passive occlusion based on the operating angle of the TMJ as related to the opposing arch occlusal contacts of the human mouth.

An example embodiment is directed to a wedge shaped dental orthotic which includes a material that covers the teeth in a thickness that increases on the occlusal surface from the most posterior to the most anterior tooth, like a wedge shape, while securely fitting over the teeth with a generally uniform thickness everywhere else (i.e., such that the remaining portions of the orthotic have a substantially uniform thickness).

In particular embodiments, the device and method described herein may provide a mechanism for maintaining and moving teeth in a physiologically correct way that increases the separation of the teeth from most posterior contact (x) to most anterior contact by a factor of about 2 times to 3 time, following the natural, anatomical separation created by the rotational opening of the TMJ.

In still other embodiments, the dental appliance 10 and associated methods described herein retains teeth with a dental appliance in a balanced position in accordance with the arc of opening of the TMJ and directly related increase of posterior to anterior opposite arch tooth separation.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### Dental Appliance and Method of Manufacturing

A dental appliance, according to various embodiments, comprises a shell defining a cavity configured to receive a plurality of teeth (e.g., maxillary or mandibular teeth). In various embodiments, the shell defines an occlusal surface that extends from each of a right and left posterior occlusal point to an anterior occlusal point. In particular embodiments, the shell has a first thickness at each of the posterior occlusal points, and a second thickness at the anterior occlusal point. In various embodiments, the second thickness is greater than the first thickness. In such embodiments, the ratios of the second thickness to the first thickness may at least partially correspond to a ratio of an anterior occlusal distance to a posterior occlusal distance of a dental patient. In particular embodiments the ratio may be between about 2:1 and about 4:1. In a particular embodiments, the ratio is 3:1.

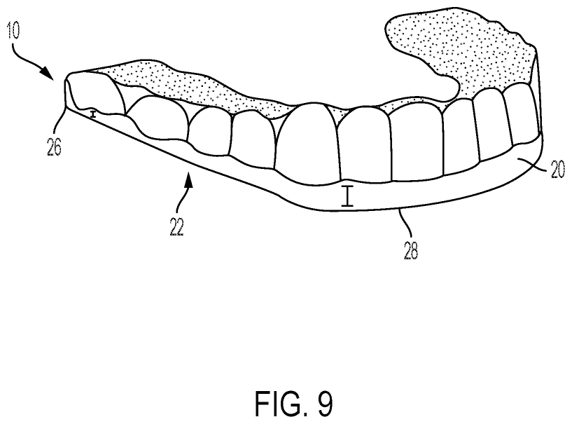

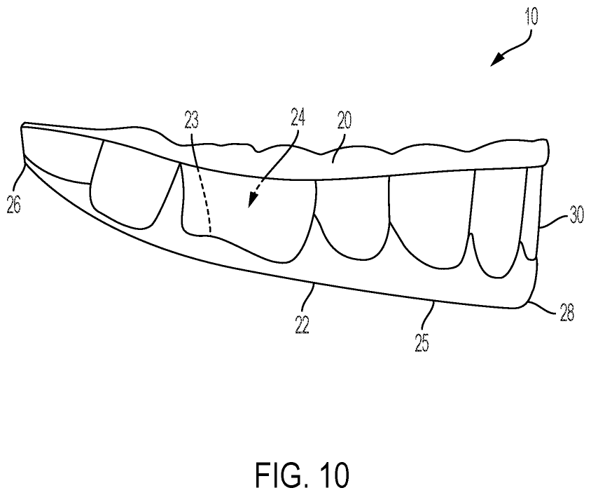

FIG. 9 depicts a dental appliance 10 according to various embodiments. As may be understood from FIG. 9, the dental appliance 10 comprises a shell 20 that extends from a posterior occlusal point 26 to an anterior occlusal point 28. Although the embodiment shown in this figure depicts a shell 20 configured to receive maxillary teeth, it should be understood that in other embodiments, a shell 20 may be configured for mandibular teeth. In various embodiments, a dental appliance 10 may include, for example: (1) an aligner; (2) a retainer; (3) a bite guard or sports mouth guard; and/or (4) any other suitable dental appliance or device. As shown in FIG. 9 and FIG. dental appliance 10, the shell 20 comprises an occlusal portion 22 and defines a cavity 24 configured to receive one or more teeth. In some embodiments, the occlusal portion 22 defines an occlusal surface that forms the bite surface of an upper or lower dental appliance 10. In various embodiments, the cavity 24 comprises a plurality of individual cavities, where each cavity cavity 24 is defined by the shape of a patient's teeth. The cavities generally correspond to one, but may correspond to multiple, individual teeth, and/or other features of a patient's dentition. In particular embodiments, the shell 20 defines a interior surface 23 configured to touch the teeth and an outer surface 25. According to various aspects, the outer surface 25 may have undulations, peaks, and cavities corresponding to the shape of the crowns or it can be substantially smooth or free of undulations, peaks, and cavities. The dental appliance 10 may be configured to engage with the crowns on the maxillary and/or mandibular arches.

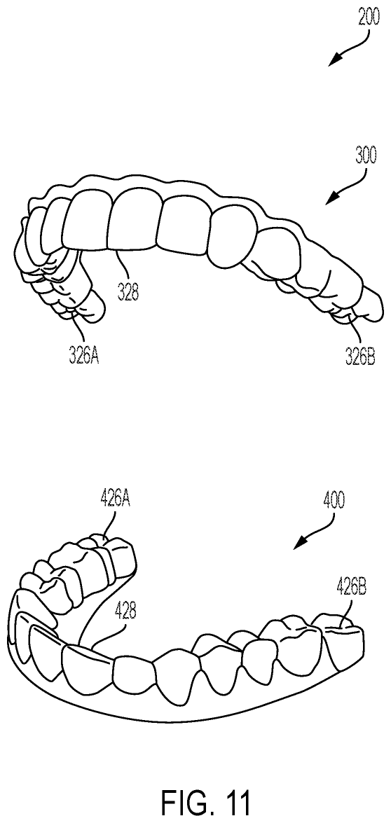

In the embodiment shown in these figures, the occlusal portion 22 of the dental appliance 10 has a thickness that increases from the posterior occlusal point 26 to the dental appliance anterior occlusal point 28, while securely fitting over the teeth. The thickness of the occlusal portion 22 can vary. In various embodiments, the occlusal portion 22 is substantially smooth (e.g., as shown in FIG. dental appliance 10). In other embodiments, as shown in FIG. 11, the occlusal portion 22 may be formed to correspond to the occlusal surface of the patients teeth (i.e., such that the occlusal portion 22 is molded in a manner that corresponds to the profile of the user's teeth). In a particular embodiment, the thickness of the occlusal surface occlusal portion 22 at the posterior occlusal point 26 is thinner than the thickness of the occlusal portion 22 at the anterior occlusal point 28. In one embodiment, the thickness of the occlusal portion 22 can gradually increase between the posterior occlusal point 26 to the anterior occlusal point 28. In this way, as discussed above, the dental appliance 10 may form a substantially wedge-shaped occlusal portion 22 such that the patient's bite while wearing the dental appliance 10 accounts for the natural ration of the posterior occlusal distance 40 to the anterior occlusal distance 44 when the patient's mouth is closed.

In particular embodiments, the dental appliance 10 may be made of any suitable hard material, for example, without limitation: acrylic, solid casted materials, 3D printed materials. In other embodiments, the dental appliance 10 may comprise a somewhat soft material, for example, without limitation, rubber, or the like.

In particular embodiments, the dental appliance 10 may be fabricated to conform to, or maintain, the present position of the patient's current dentition. In still other embodiments, the dental appliance 10 may be fabricated to impart force to any portion of any of the teeth (e.g., for re-positioning).

In various embodiments, the dental appliance 10 may define at least one sidewall 30 extending from the occlusal portion 22 and can further define the cavity 24. The at least one sidewall 30 may be configured to wrap around the sides of the teeth sufficiently to keep the dental appliance 10 in place on the patient's teeth while the patient is wearing the dental appliance 10. The thickness of the at least one sidewall 30 of may be substantially uniform. In some embodiments, the thickness of the at least one sidewall 30 is the same (e.g., or substantially the same) as the thickness of the shell 20 and/or the occlusal portion 22 at the posterior occlusal point 26. The extent of tooth coverage of the dental appliance 10 may range from laying on top of the teeth, covering the entire crown, and/or extending over the gum tissue. In various embodiments, the dental appliance 10 may have a substantially uniform thickness other than the occlusal portion 22, which may vary in thickness as described herein.

In particular embodiments, the shell 20 may have a plurality of cavities 24, each being shaped to receive the patient's teeth. In some embodiments, the shell 20 may be formed such that some of the cavities 24 are sized to measured dimensions. Each cavity 24 may be fabricated to correspond to the identified portion of the dentition having at least some dimensions larger than the measured dimensions to provide space between the dental appliance 10 and a corresponding tooth structure (e.g., one or more tooth surfaces of one or more teeth), the space adapted to contain a quantity of chemical in contact with a corresponding dentition.

As discussed herein, the posterior occlusal distance 40 is the distance between the maxillary posterior occlusion point 2 and mandibular posterior occlusion point 42. In a normal occlusion, the posterior occlusal distance 40 should be about 0 mm. The maximum distance of the posterior occlusal distance 40 may be the distance at which point the temporomandibular joint (TMJ) 1 transitions from functioning as a hinge joint to functioning as a sliding joint. The maximum distance of this posterior occlusal distance 40 may be the maximum arc the TMJ 1 can rotate before transitioning into the sliding motion. The minimum posterior occlusal distance 40 may, for example, be about 0 mm when the maxillary and mandibular teeth are contacting.

In particular embodiments, the posterior occlusal point 26 on the dental appliance 10 may be the most posterior location of the occlusal portion 22 of the dental appliance 10. The thickness of the occlusal portion 22 may be at its thinnest at the posterior occlusal point 26. In some embodiments, the occlusal portion 22, at the posterior occlusal point 26, may have a thickness that is substantially similar to the posterior occlusal distance 40. In a particular example, the occlusal portion 22 at the posterior occlusal point 26 may have a thickness of between about 5 mm and the thickness of the occlusal portion 22 at the anterior occlusal point 28 may be between about 10 mm and about 15 mm (i.e., having a ratio of about 1 to 3).

In various embodiments, the anterior occlusal distance 44 is the distance between the maxillary anterior occlusion point 3 and the mandibular anterior occlusion point 45. Due to the natural arc of occlusion, the anterior occlusal distance 44 may be about two to three times the posterior occlusal distance 40.

In particular embodiments, the anterior occlusal point 28 may include the most anterior location of the occlusal portion 22 of the dental appliance 10. The thickness of the occlusal portion 22 may be the thickest at the anterior occlusal point 28. The thickness of the occlusal portion 22 at the anterior occlusal point 28 may be substantially similar to the anterior occlusal distance 44. In one embodiment, the thickness of the occlusal portion 22 at the anterior occlusal point 28 may be more than 1-4 times the thickness of the occlusal portion 22 at the posterior occlusal point 26. In various embodiments, the thickness of the occlusal portion 22 transitions from a first thickness at the posterior occlusal point 26 to a second thickness at the anterior occlusal point 28. In various embodiments, the first thickness transitions to the second thickness along the occlusal portion 22 as the occlusal portion 22 extends from the posterior occlusal point 26 to the anterior occlusal point 28.

In particular embodiments, the dental appliance 10 is configured to maintain the position of the teeth or move teeth orthodontically, while at the same time maintaining the proper anatomical and physiological position of the mandible and maxilla.

FIG. 11 depicts yet another embodiment of a dental appliance 200. As may be understood from FIG. 11, the dental appliance 200 comprises a maxillary teeth shell 300 and a mandibular teeth shell 400. As may be understood in light of this disclosure, the maxillary teeth shell 300 and the mandibular teeth shell 400 may be configured to be worn simultaneously (e.g., by a dental patient). In various embodiments, the maxillary teeth shell 300 and mandibular teeth shell 400 may be used to adjust an alignment of any of the maxillary teeth 112 and/or the mandibular teeth 114. In the embodiment shown in this figure, the maxillary teeth shell 300 extends from a right maxillary posterior occlusal point 326A and a left maxillary posterior occlusal point 326B to a maxillary anterior occlusal point 328. Similarly, the mandibular teeth shell 400 extends from a right mandibular posterior occlusal point 426A and a left mandibular 'posterior occlusal point 426B to a mandibular anterior occlusal point 428. As may be understood in light of this disclosure, either of the occlusal portion of the maxillary teeth shell 300 and/or mandibular teeth shell 400 may be thicker at the maxillary anterior occlusal point 328 and/or mandibular anterior occlusal point 428 than at either of the right maxillary posterior occlusal point 326A, 326B left maxillary posterior occlusal point 326B, right mandibular posterior occlusal point 426A and/or 426B left mandibular posterior occlusal point 426B

In various embodiments, the occlusal portion/surface of the maxillary teeth shell 300 has a first thickness at the right maxillary posterior occlusal point 326A and the left maxillary posterior occlusal point 326B. In such embodiments, the occlusal portion/surface of the maxillary teeth shell 300 at the maxillary anterior occlusal point 328 may have a second thickness. In various embodiments, the occlusal portion/surface of the mandibular teeth shell 400 at the right mandibular posterior occlusal point 426A and the left mandibular posterior occlusal point 426B may have a third thickness. In such embodiments, the occlusal portion/surface of the mandibular teeth shell 400 at the mandibular anterior occlusal point 428 may have a fourth thickness. In particular embodiments, the combined thickness of the first thickness and the third thickness may define a fifth thickness. In such embodiments, the combined thickness of the second thickness and the fourth thickness may have a sixth thickness. In various embodiments, the sixth thickness may be greater than the fifth thickness. In various embodiments, the ratio of the fifth thickness to the sixth thickness may be any suitable thickness described herein (e.g., 1:3, 1:4, etc.). In particular embodiments, the first, second, third, and fourth thicknesses are coordinated such that the resulting fifth and sixth thicknesses provide any suitable desired relative thickness as described herein (i.e., to provide the appropriately ratioed ‘wedge’). In particular embodiments, the first and second thickness are equal, and the third and fourth thickness are sufficiently different to provide the overall desired thickness ratio. In other embodiments, the third and fourth thickness are equal, while the first and second thickness are sufficiently different to provide the overall desired thickness ratio. In this way, the maxillary teeth shell 300 and mandibular teeth shell 400 may be dimensioned to cooperate to account for the natural occlusion. That is, the thickness of various portions of the maxillary teeth shell 300 and mandibular teeth shell 400 be designed and dimensioned to provide the overall desired different in thickness between the posterior occlusal distance 40 and anterior occlusal distance 44 when the dental appliance 200 is in a patient's mouth.

In particular embodiments, prior to manufacturing the dental appliance 10, measurements of a particular patient's posterior occlusal distance 40 and anterior occlusal distance 44 may be taken. The ratio of the different may then be determined and applied to a custom dental appliance 10. This measurement can be taken, for example, by opening the patient's mouth to a desired distance (as long as the TMJ 1 is in hinge motion, i.e. not in sliding motion) and measuring the distance between the maxillary and mandibular posterior occlusal points. For instance, one could open the mouth such that the distance between the maxillary and mandibular posterior occlusal points is 1 mm and then measure the distance between the maxillary and mandibular anterior occlusal points. This may then allow a ratio of the posterior occlusal distance 40 to the anterior occlusal distance 44 to be established. This ratio may then be applied to the thickness of the occlusal portion 22 of the dental appliance 10 such that the ratio of the posterior occlusal distance 40 with the anterior occlusal distance 44 is substantially the same as the ratio of the thickness of the occlusal portion 22 at the posterior occlusal point 26 with the thickness of the occlusal portion 22 at the anterior occlusal point 28.

In various embodiments, any suitable method for manufacturing a dental appliance 10 may be employed. For example, a dental appliance 10 may be manufactured using any suitable injection molding, 3D printing or other technique. In various embodiments, each dental appliance 10 may be custom-manufactured for a patient based on molds, impressions, imaging, or other source derived from the patient's actual tooth structure. In such embodiments, the manufacturing process may incorporate the patient's actual, measured posterior occlusal distance 40 and anterior occlusal distance 44 in order to implement an appropriate thickness at various portions of the occlusal portion 22.

In particular embodiments, the dental appliance 10 is configured to fill the space between the posterior occlusal points 2/mandibular posterior occlusion point 42 and the anterior occlusal points 3/mandibular anterior occlusion point 45, by increasing the thickness of the occlusal portion 22 of the dental appliance 10 from the posterior occlusal point to the anterior occlusal point at a ratio that matches the natural arc increase in the TMJ 1. This may allow teeth to be moved or retained by the dental appliance 10 without creating a traumatic occlusion.

In various aspects, the dental appliance 10 may then be used to move teeth as with clear aligners, adding retentive elements in or around the dental appliance 10 as needed, as well as metal retentive elements such as clasps.

In particular embodiments, the dental appliance 10 can be used with occlusal guides to move the lower jaw forward, as is seen in snoring dental appliances, to open the airway. In other embodiments, the dental appliance 10 may comprise one unit into which both the top and bottom teeth occlude, that repositions the mandibular jaw slightly forward, still following the increase in occlusal thickness or tooth separation from back to front. The occlusal guides may include a bump positioned on the front of the canine (e.g., canine portion) of the dental appliance 10. This occlusal guide may mimic the canine by causing the opposing canine to engage with the occlusal guide while moving laterally, thereby creating a slope that then disengages the back teeth when moving sideways.

In still other embodiments, the dental appliance 10 may comprise a sport guard, such as a football teeth guard, in which the increase in occlusal thickness from back to front makes the dental appliance 10 more comfortable for the TMJ 1 while at the same time offering physical protection.

### CONCLUSION

Many modifications and other embodiments of the disclosure will come to mind to one skilled in the art to which this disclosure pertains having the benefit of the teachings presented in the foregoing descriptions and the associated drawings. For example, as will be understood by one skilled in the relevant field in light of this disclosure, the embodiments may take form in a variety of different mechanical and operational configurations. Therefore, it is to be understood that the disclosure is not to be limited to the specific embodiments disclosed herein, and that the modifications and other embodiments are intended to be included within the scope of the appended exemplary concepts. Although specific terms are employed herein, they are used in a generic and descriptive sense only and not for the purposes of limitation.

What is claimed is:

1. A dental appliance comprising:
a shell defining:
a cavity configured to receive a plurality of teeth; and
an occlusal portion that extends from a posterior occlusal point to an anterior occlusal point, wherein:
the shell has a first thickness at the posterior occlusal point and a second thickness at the anterior occlusal point; and
the second thickness is greater than the first thickness.

2. The dental applicant of claim 1, wherein a ratio of the second thickness to the first thickness comprises a ratio selected from the group consisting of:
a two-to-one ratio;
a three-to-one ratio; and
a four-to one ratio.

3. The dental appliance of claim 1, wherein the shell comprises at least one of:
a first shell configured to receive a plurality of maxillary teeth; or
a second shell configured to receive a plurality of mandibular teeth.

4. The dental appliance of claim 3, wherein:
the shell is the first shell configured to receive the plurality of maxillary teeth;
the dental appliance further comprises the second shell configured to receive the plurality of mandibular teeth;
the second shell defines:
a second cavity configured to receive the plurality of mandibular teeth; and
a second occlusal portion that extends from a second posterior occlusal point of the second shell to a second anterior occlusal point of the second shell;
the second shell has a third thickness at the second posterior occlusal point and a fourth thickness at the second anterior occlusal point;
the first thickness and the third thickness combine to a fifth thickness;
the second thickness and the fourth thickness combine to a sixth thickness; and
the sixth thickness is greater than the fifth thickness.

5. The dental appliance of claim 4, wherein a ratio of the sixth thickness to the fifth thickness is between about a 2:1 and a 4:1 ratio.

6. The dental appliance of claim 1, wherein the dental appliance comprise at least one of:
a retainer;
an aligner;
a bite guard; or
a sport guard.

7. The dental appliance of claim 1, wherein each portion of the shell other than the occlusal portion has a substantially uniform thickness.

8. The dental appliance of claim 7, wherein the uniform thickness is the first thickness.

9. The dental appliance of claim 1, wherein:
the occlusal portion defines a posterior occlusal surface contact point adjacent the posterior occlusal point and an anterior occlusal surface contact point adjacent the anterior occlusal point; and
the dental appliance is configured such that the posterior occlusal surface contact point and the anterior occlusal surface contact point are substantially simultaneously in contact with an opposing set of teeth when a patient is wearing the dental appliance and the patient's mouth is in a closed position.

10. A dental appliance comprising:
a maxillary teeth shell comprising a maxillary occlusal portion that extends from a right maxillary posterior occlusal point and a left maxillary posterior occlusal point to a maxillary anterior occlusal point, wherein:
the maxillary teeth shell has:
a first thickness at the right maxillary posterior occlusal point and the left maxillary posterior occlusal point; and
a second thickness at the maxillary anterior occlusal point; and
the second thickness is greater than the first thickness.

11. The dental appliance of claim 10, wherein a ratio of the second thickness to the first thickness comprises a ratio selected from the group consisting of:
a two-to-one ratio;
a three-to-one ratio; and
a four-to one ratio.

12. The dental appliance of claim 10, wherein each portion of the maxillary teeth shell other than the maxillary occlusal portion has a substantially even thickness.

13. The dental appliance of claim 12, wherein the substantially even thickness is the first thickness.

14. The dental appliance of claim 10, further comprising:
a mandibular teeth shell comprising a mandibular occlusal portion that extends from a right mandibular posterior occlusal point and a left mandibular posterior occlusal point to a mandibular anterior occlusal point, wherein:
the mandibular teeth shell has:
a third thickness at the right mandibular posterior occlusal point and the left mandibular posterior occlusal point; and
a fourth thickness at the mandibular anterior occlusal point; and
a ratio of a sum of the first thickness and third thickness to a sum of the second thickness and the fourth thickness comprises a ratio between about 1:2 and about 1:4.

15. A method of manufacturing a removable dental applicant, the method comprising:
measuring a posterior occlusal distance of a patient;
measuring an anterior occlusal distance of the patient;
determining a first ratio of the posterior occlusal distance to the anterior occlusal distance; and
manufacturing a dental appliance comprising:
a shell defining:
a cavity configured to receive a plurality of teeth; and
an occlusal portion that extends from a posterior occlusal point to an anterior occlusal point, wherein:
the shell has a first thickness at the posterior occlusal point and a second thickness at the anterior occlusal point; and
a second ratio of the first thickness to the second thickness is the first ratio.

16. The method of claim 15, wherein manufacturing the dental appliance comprises manufacturing the dental appliance such that each portion of the shell other than the occlusal portion has a substantially uniform thickness.

17. The method of claim 16, wherein the uniform thickness is the first thickness.

18. The method of claim 15, wherein manufacturing the dental appliance comprises manufacturing the shell such that the cavity is configured to receive a plurality of maxillary teeth.

19. The method of claim 15, wherein the first ration is between about 1:2 and about 1:4.

20. The method of claim 16, wherein the dental appliance further comprises:
a second shell defining:
a second cavity configured to receive a plurality of mandibular teeth; and
a second occlusal portion that extends from a second posterior occlusal point of the second shell to a second anterior occlusal point of the second shell;
the second shell has a third thickness at the second posterior occlusal point and a fourth thickness at the second anterior occlusal point;
the first thickness and the third thickness combine to a fifth thickness;
the second thickness and the fourth thickness combine to a sixth thickness; and
a third ratio of the fifth thickness to the sixth thickness is the first ratio.
